(19) United States
(12) Patent Application Publication
(10) Pub. No.: US 2023/0082977 A1
(43) Pub. Date: Mar. 16, 2023

(54) APPARATUS AND METHOD FOR TIME-OF-FLIGHT SENSING OF A SCENE

(71) Applicant: Infineon Technologies AG, Neubiberg (DE)

(72) Inventor: Hannes PLANK, Graz (AT)

(21) Appl. No.: 17/823,645

(22) Filed: Aug. 31, 2022

(30) Foreign Application Priority Data
Sep. 14, 2021 (DE) 102021123666.5

(51) Int. Cl. G01S 7/4865; G01S 17/26; G01S 17/89; G01S 7/487

(52) U.S. Cl. CPC G01S 7/4866; G01S 17/26; G01S 17/89; G01S 7/487

(57) ABSTRACT

A method for Time-of-Flight (ToF) sensing of a scene is provided. The method includes performing, by a ToF sensor including at least one photo-sensitive sensor pixel, a plurality of first ToF measurements using a first modulation frequency in order to obtain first measurement values. A respective correlation function of each of the plurality of first ToF measurements is periodic and exhibits an increasing amplitude over distance within a measurement range of the ToF sensor. The method further includes determining a distance to an object in the scene based on the first measurement values. Performing the plurality of first ToF measurements includes for at least one of the plurality of first ToF measurements controlling the photo-sensitive sensor pixel to selectively store, in at least two charge storages of the photo-sensitive sensor pixel, part of charge carriers generated in the photo-sensitive sensor pixel during the at least one of the plurality of first ToF measurements by incident light. In addition, performing the plurality of first ToF measurements includes for the at least one of the plurality of first ToF measurements controlling the photo-sensitive sensor pixel to selectively prevent another part of the charge carriers generated during the at least one of the plurality of first ToF measurements from reaching the at least two charge storages.

### CROSS REFERENCE TO RELATED APPLICATION

This application claims priority to German Patent Application No. 102021123666.5 filed on Sep. 14, 2021, the content of which is incorporated by reference herein in its entirety.

### TECHNICAL FIELD

The present disclosure relates to Time-of-Flight (ToF) sensing. In particular, examples relate to an apparatus and a method for ToF sensing of a scene.

### BACKGROUND

Close objects reflect more light in a ToF measurement since the light is less diluted. This may conventionally cause pixels of a ToF sensor to saturate. Accordingly, a dynamic range of the ToF measurement may be limited.

Further, closer (and, hence, brighter) objects also cause stray light. The stray light propagates inside a lens of the ToF sensor and between the lens and a pixel array of the ToF sensor. The propagating stray light may impair the ToF measurement.

Hence, there may be a demand for improved ToF sensing.

### SUMMARY

The demand may be satisfied by the subject-matter of the appended claims.

An example relates to a method for ToF sensing of a scene. The method includes performing, by a ToF sensor including at least one photo-sensitive sensor pixel, a plurality of first ToF measurements using a first modulation frequency in order to obtain first measurement values. A respective correlation function of each of the plurality of first ToF measurements is periodic and exhibits an increasing amplitude over distance within a measurement range of the ToF sensor. The method further includes determining a distance to an object in the scene based on the first measurement values. Performing the plurality of first ToF measurements includes for at least one of the plurality of first ToF measurements controlling the photo-sensitive sensor pixel to selectively store, in at least two charge storages of the photo-sensitive sensor pixel, part of charge carriers generated in the photo-sensitive sensor pixel during the at least one of the plurality of first ToF measurements by incident light. In addition, performing the plurality of first ToF measurements includes for the at least one of the plurality of first ToF measurements controlling the photo-sensitive sensor pixel to selectively prevent another part of the charge carriers generated during the at least one of the plurality of first ToF measurements from reaching the at least two charge storages.

Another example relates to an apparatus for ToF sensing of a scene. The apparatus includes a ToF sensor configured to perform a plurality of first ToF measurements using a first modulation frequency in order to obtain first measurement values. A respective correlation function of each of the plurality of first ToF measurements is periodic and exhibits an increasing amplitude over distance within a measurement range of the ToF sensor. The apparatus additionally includes a processing circuit configured to determine a distance to an object in the scene based on the first measurement values. The ToF sensor includes at least one photo-sensitive sensor pixel. For at least one of the plurality of first ToF measurements, the ToF sensor is configured to control the photo-sensitive sensor pixel to selectively store, in at least two charge storages of the photo-sensitive sensor pixel, part of charge carriers generated in the photo-sensitive sensor pixel during the at least one of the plurality of first ToF measurements by incident light. Further, for the at least one of the plurality of first ToF measurements, the ToF sensor is configured to control the photo-sensitive sensor pixel to selectively prevent another part of the charge carriers generated during the at least one of the plurality of first ToF measurements from reaching the at least two charge storages.

### BRIEF DESCRIPTION OF THE DRAWINGS

Some examples of apparatuses and/or methods will be described in the following by way of example only, and with reference to the accompanying figures, in which

FIG. 1 illustrates a flowchart of an example of a method for ToF sensing of a scene;

FIG. 2 illustrates an example of an apparatus for ToF sensing of a scene;

FIG. 3 illustrates example correlation functions;

FIG. 4 illustrates an example of a photo-sensitive sensor element or pixel; and

FIG. 5 illustrates an example correlation signal together with example light and state signals for a photo-sensitive sensor element or pixel.

### DETAILED DESCRIPTION

Some examples are now described in more detail with reference to the enclosed figures. However, other possible examples are not limited to the features of these implementations described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, e.g. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

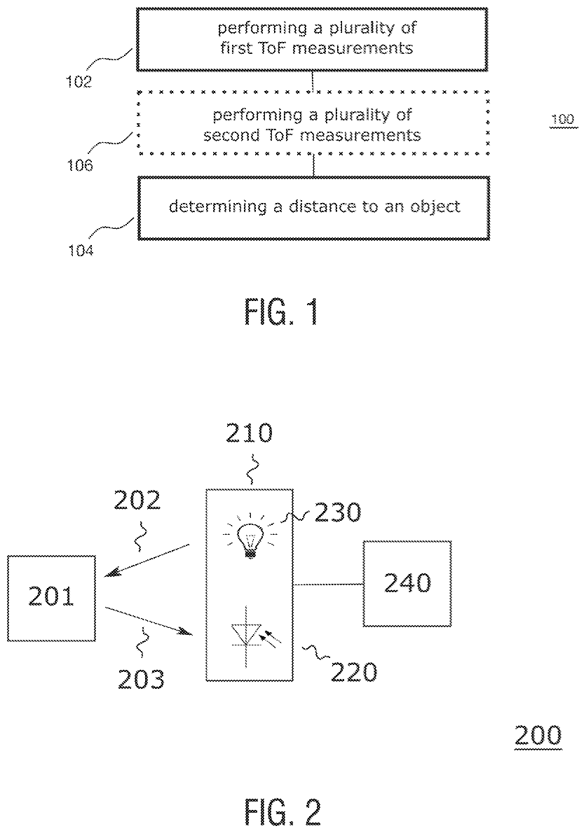

FIG. 1 illustrates a flowchart of an example of a method 100 for ToF sensing of a scene. The method 100 will be described in the following further with reference to FIG. 2 which illustrates an example apparatus 200 for ToF sensing of a scene.

The apparatus 200 comprises a ToF sensor 210. The ToF sensor 200 comprises an illumination element (circuitry, device) 230 for emitting modulated light pulses (e.g. modulated light) 202 to the scene. An object 201 is located in the scene and reflects the emitted light pulses 202. The ToF sensor 200 additionally comprises a light capturing element (circuitry, device) 220 for capturing light 203 received from the scene. The incident light 203 includes the reflections of the emitted light pulses 202 by the object 201.

The illumination element 230 generates the modulated light pulses 202. The illumination element 230 may comprise any number of light sources. The illumination element 230 may, e.g., comprise one or more Light-Emitting Diode (LED) and/or one or more laser diode (e.g. one or more Vertical-Cavity Surface-Emitting Laser, VCSEL) which is fired based on one or more illumination signal.

The light capturing element 220 may comprise various components such as e.g. optics (e.g. one or more lens) and electronic circuitry. In particular, the electronic circuitry comprises an image sensor comprising at least one photo-sensitive sensor element or pixel (e.g. comprising a Photonic Mixer Device, PMD, or a Charge-Coupled Device, CCD). For example, the image sensor may comprise a plurality of photo-sensitive sensor elements or pixels. The at least one photo-sensitive sensor element or pixel is driven based on one or more drive (reference) signal.

The method 100 comprises performing 102, by the ToF sensor 210, a plurality of first ToF measurements using a first modulation frequency in order to obtain first measurement values. The illumination element 230 emits a respective sequence of modulated light pulses to the scene during the respective first ToF measurement. Further, one or more respective drive signal is used to drive the at least one photo-sensitive sensor element or pixel of the light capture element 220 during the respective first ToF measurement.

Parameters of the ToF sensor 210 are adjusted such that a respective (light-intensity-independent) correlation function of each of the plurality of first ToF measurements is periodic and exhibits an increasing amplitude over distance within a (target) measurement range of the ToF sensor. The respective (light-intensity-independent) correlation function of each of the plurality of first ToF measurements gives the photo-sensitive sensor pixel's distance-dependent correlation of the respective incident light 203 with the one or more respective drive signal used for the respective first ToF measurement and without considering (e.g. ignoring, not taking into account) the intensity of the incident light 203. In other words, the respective (light-intensity-independent) correlation function only describes the distance-dependency of the photo-sensitive sensor pixel's output but not the dependency of the photo-sensitive sensor pixel's output on the intensity of the incident light 203. The (target) measurement range of the ToF sensor 210 is a distance range in which a distance to one or more object such as the object 201 is to be measured by the ToF sensor 210.

For example, the correlation functions of the plurality of first ToF measurements may exhibit a strictly monotonically increasing amplitude over distance within the (target) measurement range of the ToF sensor. In other examples, the respective amplitude of the correlation functions of the plurality of first ToF measurements may increase from a near end to a far end of the (target) measurement range of the ToF sensor (e.g. increase of distance) but exhibit one or more short range in which the amplitude remains constant or even (slightly) declines.

The first modulation frequency f_{mod1} is defined by the speed of light c and the period length d_{period1} of the (light-intensity-independent) correlation functions of the plurality of first ToF measurements:

$${f}_{m o d 1} = \frac{c}{2 \cdot {d}_{p e r i o d 1}} \qquad ( 1 )$$

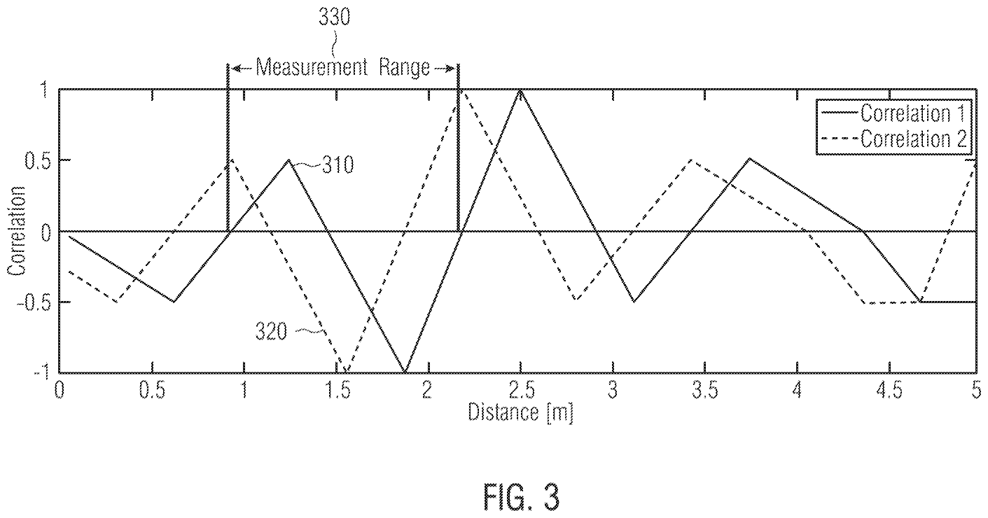

FIG. 3 illustrates two example (light-intensity-independent) correlation functions 310 and 320 of two first ToF measurements by the ToF sensor 210. The abscissa of FIG. 3 denotes the distance between the ToF sensor 210 and the object 201. The ordinate denotes the value of the respective correlation function. Further illustrated in FIG. 3 is an example measurement range 330 of the ToF sensor 210.

Both correlation functions 310 and 320 exhibit a periodic triangular course (shape) with increasing amplitudes of the triangles over distance within the measurement range 330 of the ToF sensor 210. However, it is to be noted that correlation functions according to the proposed technique need not exhibit a periodic triangular course with increasing amplitudes of the triangles over distance within the measurement range of the ToF sensor 210. In general, the correlation functions may exhibit any type of periodic course with increasing amplitude over distance within the measurement range of the ToF sensor 210. For example, the correlations functions may alternatively exhibit a sinusoidal course with increasing amplitude over distance within the measurement range of the ToF sensor 210.

The correlation functions 310 and 320 exhibit the same period length.

Further, it is to be noted that the measurement range 330 is selected for illustrative purposes only. In other examples, the measurement range may, e.g., range from 0 to 2.

Due to the increasing amplitude of the correlation functions 310 and 320 within the measurement range 330 of the ToF sensor 210, the first ToF measurements are less sensitive to incident light 203 coming from the close proximity of the ToF sensor 210. In other words, the correlation functions 310 and 320 are shaped such that more correlation strength is given to distances (regions) further away from the ToF sensor 210. As a consequence, near distances (regions) get less correlation and far distances (regions) get higher correlation.

The light strength of reflections received from the object 201 in the scene is decreasing over the distance between the ToF sensor 210 and the object 201. For example, it may be assumed that the light strength decreases according to the inverse square law. That is, the distance-dependent light strength of the incident light 203 received at the ToF sensor 210 may be assumed as follows:

$$I ( d ) ∝ \frac{1}{{d}^{2}} \qquad ( 2 )$$

with I denoting the light strength of the light received at the ToF sensor 210 and d denoting distance between the ToF sensor 210 and the object 201 reflecting the emitted light pulses 202 back to the ToF sensor 210.

As the sensitivity of the ToF sensor 210 for light from the close proximity of the ToF sensor 210 is reduced, saturation of the at least one photo-sensitive sensor element or pixel of the light capture element 220 due to strong reflections from the close proximity of the ToF sensor 210 may be avoided. Additionally, glare effects or stray light effects caused by reflections of the emitted light pulses 202 by an object in the close proximity of the ToF sensor 210 may be omitted or at least reduced.

The output of the at least one photo-sensitive sensor element or pixel for a ToF measurement scales with the light strength of reflections received from the object 201. For example, the first measurement value output by the at least one photo-sensitive sensor element or pixel for one of the plurality of first ToF measurements may be determined by the product of the light strength of the reflections received from the object 201 during this ToF measurement and the value of the ToF measurement's (light-intensity-independent) correlation function at the distance of the object 201 causing the received reflections.

Further, the periodic course of the correlation functions allows to determine the distance between the ToF sensor 210 and the object 201 according to standard approaches. Referring back to FIG. 1, the method 100 further comprises determining 104 a distance to the object 201 in the scene based on the first measurement values.

In particular, the first measurement values allow to determine a respective phase shift between the one or more respective drive (reference) signal used for driving the at least one photo-sensitive sensor element or pixel of the light capture element 220 during the respective first ToF measurement and the respective incident light 203 (e.g. the reflections of the emitted light pulses 202 caused by the object 201) received from the scene by the light capture element 230 during the respective first ToF measurement.

For example, in case two first ToF measurements are performed, the phase shift φ may be determined as follows:

$$φ = a tan 2 ( \frac{{C}_{2}}{{C}_{1}} ) \qquad ( 3 )$$

with C₁ and C₂ denoting the first measurement values of the two first ToF measurements.

In case four first ToF measurements are performed, the phase shift φ may be determined as follows:

$$φ = a tan 2 ( \frac{{C}_{2} - {C}_{4}}{{C}_{1} - {C}_{3}} ) \qquad ( 4 )$$

with C₁, C₂, C₃ and C₄ denoting the first measurement values of the four first ToF measurements.

It is to be noted that different time offsets are used respectively for the plurality of first ToF measurements between the respective sequence of modulated light pulses 202 emitted to the scene during the respective first ToF measurement and the one or more respective drive (reference) signal used to drive the at least one photo-sensitive sensor element or pixel of the light capture element 220 during the respective first ToF measurement. The time offsets used for the first ToF measurements are integer multiples of a fraction of a first period length T₁ given by the inverse of the first modulation frequency f_{mod1}, that is:

$${T}_{1} = \frac{1}{{f}_{m o d 1}} \qquad ( 5 )$$

For example, time offsets n·T₁/4 with n=0, 1 may be used in case two first ToF measurements are performed. Similarly, time offsets n·T₁/4 with n=0, 1, 2, 3 may be used in case four first ToF measurements are performed. The sequences of modulated light pulses 202 emitted to the scene during the first ToF measurements may be identical. Accordingly, there may be a time shift of n·T₁/4 between the one or more respective drive (reference) signal of the different first ToF measurements. The first measurement values Cᵢ are related to the parameter n as follows:

i=n+1 (6)

Performing four first ToF measurements instead of two first ToF measurements may allow to reject errors related to the least one photo-sensitive sensor element or pixel of the light capture element 220. For example, gain errors or errors due to background light may be compensated for. The error compensation is possible as two pairs of ToF measurements are performed with inverted storage behavior of the at least one photo-sensitive sensor pixel (the storage behavior of the at least one photo-sensitive sensor pixel for n=0, 2 is inverted and the storage behavior of the at least one photo-sensitive sensor pixel for n=1, 3 is inverted) such that the differences C₂−C₄ and C₁−C₃ cancel out these errors. However, it is to be noted that the present technology is not limited to performing two or four first ToF measurements. In general, any number l≥2 of ToF measurements may be performed.

The distance d of the ToF sensor 210 to the object 201 may be determined based on the phase shift φ as follows:

$$d = \frac{c}{2} \cdot \frac{φ}{2 π \cdot {f}_{m o d 1}} \qquad ( 7 )$$

The apparatus 200 comprises an accordingly configured processing circuit 240, which is coupled to the ToF sensor 210. For example, the processing circuit 240 may be a single dedicated processor, a single shared processor, or a plurality of individual processors, some of which or all of which may be shared, a digital signal processor (DSP) hardware, an application specific integrated circuit (ASIC) or a field programmable gate array (FPGA). The processing circuit 240 may optionally be coupled to, e.g., read only memory (ROM) for storing software, random access memory (RAM) and/or non-volatile memory. The processing circuit 240 is configured to determine the distance to the object 201 in the scene based on the first measurement values.

For example, the processing circuit 240 may further output data indicative of the distance to the object 201 (e.g. a two-dimensional depth image or a three-dimensional point cloud).

The apparatus 200 may comprise further hardware-conventional and/or custom.

The method 100 as well as the apparatus 200 may allow to determine the distance to the object 201 in the scene while omitting stray light effects, glare effects and saturation of the at least one photo-sensitive sensor element or pixel of the light capture element 220. Further, an improved dynamic range of the ToF sensor 210 may be achieved. In other words, the method 100 and the apparatus 200 may allow improved ToF sensing.

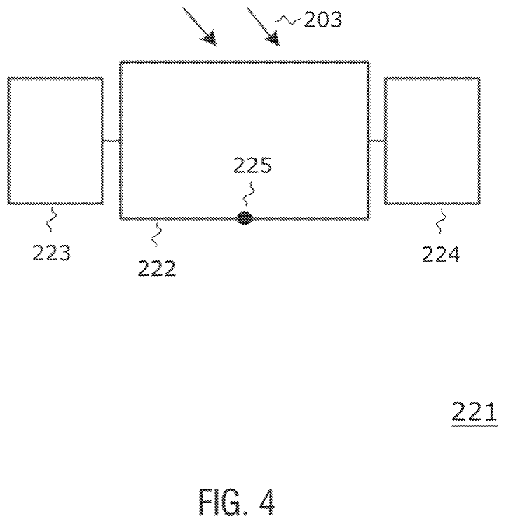

The course (shape) of the (light-intensity-independent) correlation functions of the plurality of first ToF measurements is adjusted by controlling the flow of charge carriers inside the at least one photo-sensitive sensor element or pixel. This will be explained in the following with reference to FIG. 4 illustrating an example photo-sensitive sensor element or pixel 221.

The photo-sensitive sensor element or pixel 221 comprises a semiconductor material/substrate 222 (e.g. silicon). The incident light 203 (including the reflections from the object 201) penetrates the semiconductor material 222 and causes generation of charge carriers (e.g. electrons or holes) in the semiconductor material 222.

The photo-sensitive sensor element or pixel 221 further comprises two charge storages 223 and 224. For example, the two charge storages 223 and 224 may be capacitors or potential wells formed in the semiconductor material 222 of the photo-sensitive sensor element or pixel 221. It is to be noted that the charge storages 223 and 224 are illustrated as separate elements in FIG. 4 for illustrative purposes only. The two charge storages are part of the photo-sensitive sensor element or pixel 221. The two charge storages allow to selectively store the generated charge carriers. Although exactly two charge storages are illustrated in FIG. 4 for photo-sensitive sensor element or pixel 221, it is to be noted that the present disclosure is not limited thereto. In general any number M≥2 of charge storages may be used per photo-sensitive sensor element or pixel.

When performing the plurality of first ToF measurements, the photo-sensitive sensor element or pixel 221 is for at least one of the plurality of first ToF measurements controlled to selectively store, in the at least two charge storages 223 and 224 of the photo-sensitive sensor element or pixel 221, part of the charge carriers generated in the semiconductor material 222 of the photo-sensitive sensor element or pixel 221 during the at least one of the plurality of first ToF measurements by the incident light 203.

Additionally, the photo-sensitive sensor element or pixel 221 comprises a drain terminal 225. The drain terminal 225 is a terminal that allows to selectively drain the generated charge carriers from the photo-sensitive sensor element or pixel 221.

In order to adjust the above described course (shape) of the (light-intensity-independent) correlation functions of the plurality of first ToF measurements, the photo-sensitive sensor element or pixel 221 is for at least one of the plurality of first ToF measurements controlled to selectively store part (a first fraction/share) of the charge carriers, which are generated during the at least one of the plurality of first ToF measurements by the incident light 203, in the at least two charge storages 223 and 224 and to selectively drain another part (a second fraction/share) of these charge carriers via the drain terminal 225. In other words, the photo-sensitive sensor element or pixel 221 is for at least one of the plurality of first ToF measurements controlled to selectively prevent the other part of the charge carriers from reaching the at least two charge storages 223 and 224.

Only the charge carriers selectively stored in the at least two charge storages 223 and 224 during the respective first ToF measurement contribute to the respective correlation function of each of the plurality of first ToF measurements. Accordingly, by selectively preventing some of the generated charge carriers from reaching the at least two charge storages 223 and 224, the course of the respective correlation function may be shaped.

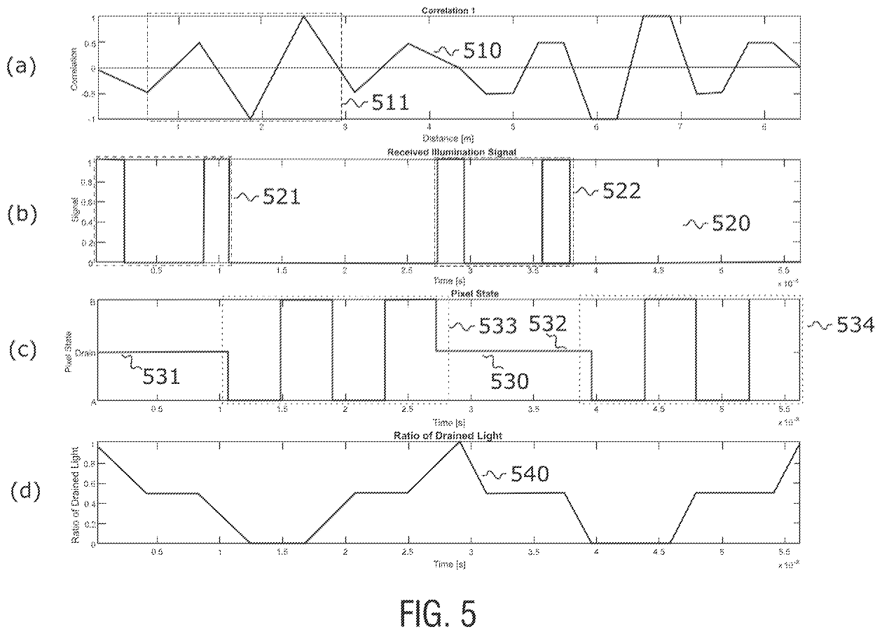

FIG. 5 illustrates in subfigure (a) an example correlation function 510 of one of the plurality of first ToF measurements of the ToF sensor 210. The abscissa of subfigure (a) denotes the distance between the ToF sensor 210 and the object 201. The ordinate denotes the value of the respective correlation function. In the example of FIG. 5, the (target) measurement range 511 of the ToF sensor 210 ranges from approx. 0.7 to approx. 2.9. Similar to the example of FIG. 3, the correlation function 510 exhibits a periodic triangular course (shape) with increasing amplitudes of the triangles over distance within the measurement range 511 of the ToF sensor 210.

Subfigure (b) of FIG. 5 illustrates an example sequence of light pulses 520 that are received from the scene. The light pulses 520 are previously emitted to scene by the light emitting element 230 for the one of the plurality of first ToF measurements and are reflected back to the ToF sensor 210 by an object in the scene. The abscissa of subfigure (b) denotes time. The ordinate denotes the amplitude of the light pulses 520. As can be seen from subfigure (b), the light pulses are emitted in groups by the light emitting element 230. Two example groups of light pulses 521 and 522 are illustrated in the example of FIG. 5. However, it is to be noted that any other number G≥2 of groups of light pulses may be emitted during the one of the plurality of first ToF measurements. Each group 521, 522 comprises at least two light pulses.

The (time) duration (spacing, time delay) between the groups of light pulses may vary during the exposure for the one of the plurality of first ToF measurements. In other examples, the (time) duration between the groups of light pulses may be constant during the exposure for the one of the plurality of first ToF measurements. The (time) duration (spacing, time delay) between two (immediately) subsequent light pulses in each of the groups may be constant. However, the present disclosure is not limited thereto.

Each of the (time) duration separating two (immediately) subsequent light pulses in the group 521 and the (time) duration separating two (immediately) subsequent light pulses in the group 522 is shorter than the (time) duration separating the two subsequent groups 521 and 522. In general (e.g. independent of the number of groups of light pulses and the number of light pulses within each group), a longest duration separating two (immediately) subsequent light pulses within each of the groups of light pulses may be shorter than a duration separating two (immediately) subsequent ones of the groups of light pulses.

Subfigure (c) of FIG. 5 illustrates an example temporal course 530 of the photo-sensitive sensor element or pixel 221's state during the one of the plurality of first ToF measurements. The abscissa of subfigure (c) denotes time. The ordinate denotes the state of the photo-sensitive sensor element or pixel 221. As indicated in subfigure (c) of FIG. 5, three states are possible.

While the photo-sensitive sensor element or pixel 221 is in state “A”, the photo-sensitive sensor element or pixel 221 selectively stores the charge carriers, which are generated during the at least one of the plurality of first ToF measurements by the incident light 203, in the charge storage 223 (but not in the charge storage 224). While the photo-sensitive sensor element or pixel 221 is in state “B”, the photo-sensitive sensor element or pixel 221 selectively stores the charge carriers, which are generated during the at least one of the plurality of first ToF measurements by the incident light 203, in the charge storage 224 (but not in the charge storage 223). While the photo-sensitive sensor element or pixel 221 is in state “Drain”, the photo-sensitive sensor element or pixel 221 selectively drains the charge carriers, which are generated during the at least one of the plurality of first ToF measurements by the incident light 203, via the drain terminal 225. No charge carriers are stored in the charge storages 223 and 224 while the photo-sensitive sensor element or pixel 221 is in the state “Drain”.

The states “A” and “B” may each be understood as an integration state for the respective one of the charge storages 223 and 224. In other words, the photo-sensitive sensor element or pixel 221 provides a respective integration state for each of the least two charge storages 223 and 224 during which the charge carriers are being stored in the corresponding (respective) charge storage. The state “Drain” may be understood as a drain (non-integrating) state of the photo-sensitive sensor element or pixel 221. In other words, the photo-sensitive sensor element or pixel 221 further provides a drain (non-integrating) state during which the charge carriers are prevented from reaching the at least two charge storages 223 and 224.

As can be seen from subfigure (c), the photo-sensitive sensor element or pixel 221 is controlled to operate according to a state pattern during the one of the plurality of first ToF measurements. The state pattern comprises first the drain state, followed by a sequence of integration states during which the charge carriers are alternatingly stored in the least two charge storages 223 and 224. In the example of FIG. 5, the state pattern is repeated two times. However, it is to be noted that in general any number P≥1 of state patterns may be used for the one of the plurality of first ToF measurements.

The first state pattern comprises the drain state 531 followed by the sequence 533 of integration states during which the charge carriers are alternatingly stored in the least two charge storages 223 and 224. The second state pattern comprises the drain state 532 followed by the sequence 534 of integration states during which the charge carriers are alternatingly stored in the least two charge storages 223 and 224. The respective sequence of integration states may comprise an even as well as an odd number of integration states.

For example, the photo-sensitive sensor element or pixel 221 may be controlled for the one of the plurality of first ToF measurements to (e.g. continuously and) repeatedly operate according to the state pattern over time. As illustrated in subfigure (c) for the sequences 533 and 534, each two subsequent sequences of integration states are separated by a drain state in case the state pattern is repeated over time.

In the example of FIG. 5, the sequences 533 and 534 are identical, e.g. the integration states in each sequence of integration states are of the same duration and each sequence of integration states comprises the same number of integration states. In other words, the integration states within a respective one of the first sequence of integration states 533 and the second sequence of integration states 534 may have a same duration. As illustrated in subfigure (c), the duration of each state “A” in the sequences of integration states 533, 534 is equal to the duration of each state “B” in the sequences of integration states 533, 534. In other examples, a duration of the first integration state (e.g. state “A” or state “B”) may be short or longer than a respective duration of the other integration states in a respective sequence of integration states (e.g. the duration of the first state “A” in the sequence 533 may be longer or short than the durations of the other states “A” and “B” in the sequence 533).

However, the present disclosure is not limited to identical sequences. In other examples, the sequences of integration states may be different. In case, the photo-sensitive sensor element or pixel 221 is controlled for the one of the plurality of first ToF measurements to operate two or more times according to the state pattern over time, two or more sequences of integration states are used. Accordingly, a first sequence of the two or more sequences of integration states may be different from a second sequence of the two or more sequences of integration states. For example, the first sequence of integration states and the second sequence of integration states may have (exhibit) integration states of different durations. Alternatively or additionally, the first sequence of integration states and the second sequence of integration states may have (exhibit) different respective numbers of integration states.

Subfigure (d) of FIG. 5 illustrates an example distance dependent ratio 540 of the generated charge carriers selectively drained via the drain terminal 225. The abscissa of subfigure (d) denotes the distance between the ToF sensor 210 and the object 201. The ordinate denotes the ratio of drained charged carriers. As can be seen from subfigure (d), the photo-sensitive sensor element or pixel 221 is controlled to decrease the ratio of drained charged carriers with increasing distance of the object 201 (causing the incident light 203) to the ToF sensor 210. In other words, the photo-sensitive sensor element or pixel 221 is controlled to increase a ratio of the generated charge carriers selectively stored in the at least two charge storages 223 and 224 with increasing distance of the ToF sensor 210 to the object 201 causing the incident light 203.

As can be seen from subfigure (d), only a portion of the charge carriers generated by light reflections coming from the start of the measurement range gets stored in the at least two charge storages 223 and 224. The stored charge carriers contribute to the correlation function 510 illustrated in subfigure (a). The rest of the charge carriers is removed (drained) from the photo-sensitive sensor element or pixel 221 via the drain terminal 225 and, hence, not stored in the at least two charge storages 223 and 224. This is achieved as the incident light 203 causing these charge carriers arrives while the photo-sensitive sensor element or pixel 221 is in the state “Drain”, e.g. the respective drain state 531, 533 of the photo-sensitive sensor element or pixel 221. A respective duration of the drain state 531, 533 is chosen to reach a predetermined amount of charge carriers being integrated into the at least two charge storages 223 and 224 during the subsequent sequence of integration states, e.g., the sequences 533 and 534 illustrated in subfigure (c). Charge carriers caused by incident light 203 from the far end of the measurement range are substantially completely stored in the at least two charge storages 223 and 224 and, hence, contribute more to the correlation function 510 illustrated in subfigure (a). In other words, the reflected groups of light pulses increasingly overlap with the sequence of integration states over distance within the measurement range of the ToF sensor 210. Accordingly, the amplitude of the correlation function 510 increase over distance within the measurement range of the ToF sensor 210. The increase of the correlation may be adjusted to the application. For example, only a certain portion of the measurement range may be partly drained, while the rest is completely captured.

For example, the longest sequence of integration states used for the one of the plurality of first ToF measurements may have (exhibit) a number of integration states that is equal to or greater than a number of peaks of the correlation function within the (target) measurement range of the ToF sensor 210. Accordingly, no light is wasted.

Optionally, the photo-sensitive sensor element or pixel 221 may comprise one or more further elements such as control gates for controlling the flow of the generated charge carriers inside the photo-sensitive sensor pixel (e.g. two or more modulation gates and/or one or more drain gates) or read-out terminals for reading out the at least two charge storages. For example, the photo-sensitive sensor element or pixel 221 may be a PMD or a CCD. According to examples, more than one (e.g. all) of the plurality of photo-sensitive sensor element or pixels of the ToF sensor may be formed and operated like the photo-sensitive sensor element or pixel 221. The operation of the photo-sensitive sensor element or pixel 221 is controlled based on the one or more drive (reference) signal.

In the example of FIG. 4, the photo-sensitive sensor element or pixel 221 comprises the drain gate 225 for draining and, hence, preventing part of the generated charge carriers from reaching the at least two charge storages 223 and 224. However, it is to be noted that the present disclosure is not limited thereto. In other examples, the drain gate 225 may be omitted and the photo-sensitive sensor element or pixel 221 may be configured to electrically decouple (isolate) the at least two charge storages 223 and 224 from the semiconductor material 222 such that the generated charge carriers cannot reach the at least two charge storages 223 and 224. In general, any technique may be used for preventing part of the charge carriers generated during the at least one of the plurality of first ToF measurements from reaching the at least two charge storages 223 and 224.

There are various, substantially infinite ways on how to configure (shape) the one or more reference (drive) signal driving the respective photo-sensitive sensor element or pixel of the light capturing element 220 and the one or more illumination signal for driving the illumination element 230 in order to create correlation functions that behave like in the above described examples of FIG. 3 and FIG. 5. Therefore, it is to be noted that the present disclosure is not limited to the specific configuration (shape) of the one or more reference (drive) signal and the one or more illumination signal. The signal structures illustrated in FIG. 5 are, hence, merely for illustration. In general, the one or more reference (drive) signal and the one or more illumination signal are chosen such that charge carriers caused by incident light 203 from closer ranges are drained to a certain extent in order to cause the respective correlation function to increase over distance.

As described above, the storage behavior of the at least one photo-sensitive sensor pixel may be inverted between pairs of the plurality of first ToF measurements in order to compensate for errors such as gain errors or errors due to background light. For example, for the first ToF measurement illustrated in subfigure (c) of FIG. 5, the photo-sensitive sensor element or pixel 221 is controlled to selectively store the charge carriers generated during the first ToF measurement in the at least two charge storages 223 and 224 according to the first storage order ABABABAB (when neglecting the drain intervals), wherein “A” denotes that the charges are stored in the charge storage 223 and “B” denotes that the charges are stored in the charge storage 224. In another one of the plurality of ToF measurements, the photo-sensitive sensor element or pixel 221 may be controlled to selectively store the charge carriers generated during the other first ToF measurement in the at least two charge storages 223 and 224 according to the second storage order BABABABA (assuming the same drain intervals in both first ToF measurements). The second storage order is inverted with respect to the first storage order. This effect may, e.g., be achieved if the two time offsets between the respective sequence of emitted modulated light pulses 202 and the one or more respective drive (reference) signal differ by a time shift of 2·T₁/4 for the two first ToF measurements.

It is to be noted that the aspects described above for the one of the first ToF measurements may be used as well for the other first ToF measurements.

Another aspect for ToF sensing is the ambiguity of the ToF measurement. The maximum unambiguous distance range dᵤ of a ToF measurement is inversely proportional to the modulation frequency f_{mod}:

$${d}_{u} = \frac{c}{2 \cdot {f}_{m o d}} \qquad ( 8 )$$

Objects measured beyond this distance are wrapped around to fall in the range [0,dᵤ), appearing much closer than they actually are. Lowering the modulation frequency f_{mod} would allow to extend the unambiguous distance range dᵤ, results however in reduced precision of the distance measurement.

The ambiguity of the distance measurement may be overcome by performing additional ToF measurements at a different second modulation frequency. Referring back to FIGS. 1 and 2, the method 100 may optionally further comprise performing 106, by the ToF sensor 210, a plurality of second ToF measurements using a second modulation frequency in order to obtain second measurement values. The second modulation frequency is different from the first modulation frequency (e.g. higher or lower). Similar to what is described above for the first ToF measurements, a respective correlation function of each of the plurality of second ToF measurements is periodic and exhibits an increasing amplitude over distance within the measurement range of the ToF sensor 210. Analogously to what is described above for the correlation functions of the plurality of first ToF measurements, the respective correlation function of each of the plurality of second ToF measurements gives the photo-sensitive sensor pixel 221's distance-dependent correlation of the respective incident light 203 with the one or more respective drive signal used for the respective second ToF measurement and without considering (e.g. ignoring, not taking into account) the intensity of the incident light 203. In other words, the respective (light-intensity-independent) correlation function only describes the distance-dependency of the photo-sensitive sensor pixel 221's output but not the dependency of the photo-sensitive sensor pixel 221's output on the intensity of the incident light 203.

The step of determining 104 the distance of the ToF sensor 210 to the object 201 in the scene is then further based on the second measurement values.

Analogously to above mathematical expression (1), the second modulation frequency f_{mod2} may be defined by the speed of light c and the period length d_{period2} of the (light-intensity-independent) correlation functions of the plurality of second ToF measurements:

$${f}_{m o d 2} = \frac{c}{2 \cdot {d}_{p e r i o d 2}} \qquad ( 9 )$$

Analogously to what is described above for the plurality of first ToF measurements, different time offsets are used respectively for the plurality of second ToF measurements between the respective sequence of modulated light pulses 202 emitted to the scene during the respective second ToF measurement and the one or more respective drive (reference) signal used to drive the at least one photo-sensitive sensor element or pixel of the light capture element 220 during the respective second ToF measurement. The time offsets used for the second ToF measurements are integer multiples of a fraction of a second period length T₂ given by the inverse of the second modulation frequency f_{mod2}, that is:

$${T}_{2} = \frac{1}{{f}_{m o d 2}} \qquad ( 10 )$$

For example, time offsets n·T₂/4 with n=0, 1 may be used in case two second ToF measurements are performed. Similarly, time offsets n·T₂/4 with n=0, 1, 2, 3 may be used in case four second ToF measurements are performed. The sequences of modulated light pulses 202 emitted to the scene during the second ToF measurements may be identical. Accordingly, there may be a time shift of n·T₂/4 between the one or more respective drive (reference) signal of the different second ToF measurements.

As described above, if the object 201 is located beyond the unambiguous distance dᵤ₁ of the first ToF measurements, it is wrapped around to fall in the unambiguous distance range [0,dᵤ₁) of the first ToF measurements. Analogously, if the object 201 is located beyond the unambiguous distance dᵤ₂ of the second ToF measurements, it is wrapped around to fall in the unambiguous distance range [0,dᵤ₂) of the second ToF measurements. Accordingly, the object 201 appears much closer than it actually is.

In other words, the plurality of first ToF measurements as well as the plurality of second ToF measurements each give a few possible distances for the object 201.

The possible distances of the object 201 to the ToF sensor 210 for the first ToF measurements is given by:

$${d}_{1} = \frac{c}{2} \cdot \frac{{φ}_{1}}{2 π \cdot {f}_{m o d 1}} + {k}_{1} \cdot \frac{c}{2 \cdot {f}_{m o d 1}} = \frac{c}{2} \cdot \frac{{φ}_{1}}{2 π \cdot {f}_{m o d 1}} + {k}_{1} \cdot {d}_{u 1} \qquad ( 11 )$$

φ₁ denotes the phase value determined from the first measurement values according to, e.g., one of mathematical expressions (3) and (4). The first term of mathematical expression (11) corresponds to above mathematical expression (7). The second term of mathematical expression (11) is based on above mathematical expression (8) and describes that actual distance of the object 201 may be k₁ times the unambiguous distance dᵤ₁ of the first ToF measurements greater than the distance determined according to mathematical expression (7) due to the phase wrapping, wherein k₁=0,1,2, . . .

Analogously, the possible distances of the object 201 to the ToF sensor 210 for the second ToF measurements is given by:

$${d}_{2} = \frac{c}{2} \cdot \frac{{φ}_{2}}{2 π \cdot {f}_{m o d 2}} + {k}_{2} \cdot \frac{c}{2 \cdot {f}_{m o d 2}} = \frac{c}{2} \cdot \frac{{φ}_{2}}{2 π \cdot {f}_{m o d 2}} + {k}_{2} \cdot {d}_{u 2} \qquad ( 12 )$$

φ₂ denotes the phase value determined from the second measurement values according to, e.g., one of mathematical expressions (3) and (4). The first term of mathematical expression (12) corresponds to above mathematical expression (7). The second term of mathematical expression (12) is based on above mathematical expression (8) and describes that actual distance of the object 201 may be k₂ times the unambiguous distance dᵤ₂ of the second ToF measurements larger than the distance determined according to mathematical expression (7), wherein k₂=0,1,2, . . .

The mathematical expressions (11) and (12) are only for one specific distance, e.g., for one specific value pair for the parameters k₁ and k₂ in agreement. For example, it may be determined for which integer values of the parameters k₁ and k₂ the distances d₁ and d₂ according to the mathematical expressions (11) and (12) are identical to each other or differ from each other by less than a threshold value (to account for the limited measurement precision). Accordingly, a first distance estimate d₁ may be determined according to mathematical expression (11) based on the first measurement values. Analogously, a second distance estimate d₂ may be determined according to mathematical expression (12) based on the second measurement values.

The distance d to the object 201 may be determined based on the first distance estimate d₁ and the second distance estimate d₂. For example, both distance estimates may be averaged to account for measurement errors of the plurality of first ToF measurements and the plurality of second ToF measurements:

$$d = \frac{{d}_{1} + {d}_{2}}{2} \qquad ( 13 )$$

In other examples, weighted averaging may be used:

d=w₁·d₁+w₂·d₂ (14)

The weights w₁ and w₂ may be based on various parameters such as the first and second modulation frequencies or the amplitudes of the first and second measurement values.

The course (shape) of the (light-intensity-independent) correlation functions of the plurality of second ToF measurements may be adjusted analogously to what is described for the correlation functions of the plurality of ToF first measurements by controlling the flow of charge carriers inside the at least one photo-sensitive sensor element or pixel 221. This will be described in the following for one of the second ToF measurements. It is to be noted that the aspects described in the following may be used as well for the other second ToF measurements.

Analogously to what is described above for the first ToF measurements, performing the plurality of second ToF measurements comprises for at least one of the plurality of second ToF measurements controlling the photo-sensitive sensor element or pixel 221 to selectively store, in the at least two charge storages 223 and 224 of the photo-sensitive sensor element or pixel 221, part of the charge carriers generated in the photo-sensitive sensor element or pixel 221 during the at least one of the plurality of second ToF measurements by the incident light 203. Further, performing the plurality of second ToF measurements comprises for the at least one of the plurality of second ToF measurements controlling the photo-sensitive sensor element or pixel 221 to selectively prevent another part of the charge carriers generated during the at least one of the plurality of second ToF measurements by the incident light 203 from reaching the at least two charge storages 223 and 224. For example, the photo-sensitive sensor element or pixel 221 may be controlled to selectively drain part of the charge carriers generated during the at least one of the plurality of second ToF measurements by the incident light 203 via the drain terminal 225.

Only the charge carriers selectively stored in the at least two charge storages 223 and 224 during the respective second ToF measurement contribute to the respective correlation function of each of the plurality of second ToF measurements. Accordingly, by selectively preventing some of the charge carriers from reaching the at least two charge storages 223 and 224, the course of the respective correlation function may be shaped. For example, the photo-sensitive sensor element or pixel 221 may be controlled to increase a ratio of the charge carriers selectively stored in the at least two charge storages 223 and 224 during the respective second ToF measurement with increasing distance of the ToF sensor 210 to the object 201 causing the incident light 203. In other words, the photo-sensitive sensor element or pixel 221 may be controlled to decrease the ratio of drained charged carriers in the respective second ToF measurement with increasing distance of the object 201 (causing the incident light 203) to the ToF sensor 210.

Analogously to what is described above for the first ToF measurements, the storage behavior of the at least one photo-sensitive sensor element or pixel may be inverted between pairs of the plurality of second ToF measurements in order to compensate for errors such as gain errors or errors due to background light. For example, for one of the plurality of second ToF measurements, the photo-sensitive sensor element or pixel may be controlled to selectively store part of the charge carriers generated during the one of the plurality of second ToF measurements in the at least two charge storages according to a third storage order. For another one of the plurality of second ToF measurements, the photo-sensitive sensor element or pixel may be controlled to selectively store part of the charge carriers generated during the other one of the plurality of second ToF measurements in the at least two charge storages according to a fourth storage order. The fourth storage order is inverted with respect to the third storage order.

It may be beneficial for the above described phase unwrapping to have the highest amplitudes of the correlation functions of both the first ToF measurements and the second ToF measurements in substantially the same distance region. For example, the correlation functions of the plurality of first ToF measurements may exhibit their respective maximum amplitude at first distances and the correlation functions of the plurality of second ToF measurements may exhibit their respective maximum amplitude at second distances such that the first distances differ by less than 20%, 10% or 5% from the second distances.

According to some examples, a course of a ratio of the correlation functions of any two of the first ToF measurements may be strictly monotonic decreasing or strictly monotonic increasing (over distance) in the measurement range of the ToF sensor 210. Analogously, a course of a ratio of the correlation functions of any two of the second ToF measurements may be strictly monotonic decreasing or strictly monotonic increasing (over distance) in the measurement range of the ToF sensor 210. A strictly monotonic decreasing or increasing ratio may enable unambiguous ToF measurements.

### Aspects

The aspects as described herein may be summarized as follows:

Aspects relate to a method for ToF sensing of a scene. The method includes performing, by a ToF sensor including at least one photo-sensitive sensor pixel, a plurality of first ToF measurements using a first modulation frequency in order to obtain first measurement values. A respective correlation function of each of the plurality of first ToF measurements is periodic and exhibits an increasing amplitude over distance within a measurement range of the ToF sensor. The method further includes determining a distance to an object in the scene based on the first measurement values. Performing the plurality of first ToF measurements includes for at least one of the plurality of first ToF measurements controlling the photo-sensitive sensor pixel to selectively store, in at least two charge storages of the photo-sensitive sensor pixel, part of charge carriers generated in the photo-sensitive sensor pixel during the at least one of the plurality of first ToF measurements by incident light. In addition, performing the plurality of first ToF measurements includes for the at least one of the plurality of first ToF measurements controlling the photo-sensitive sensor pixel to selectively prevent another part of the charge carriers generated during the at least one of the plurality of first ToF measurements from reaching the at least two charge storages.

According to some aspects, the photo-sensitive sensor pixel provides a respective integration state for each of the least two charge storages during which the charge carriers are being stored in the corresponding charge storage, wherein the photo-sensitive sensor pixel further provides a drain state during which the charge carriers are prevented from reaching the at least two charge storages, and wherein performing the plurality of first ToF measurements includes, for at least the one of the plurality of first ToF measurements, controlling the photo-sensitive sensor pixel to operate according to a state pattern, the state pattern including first the drain state, followed by a sequence of integration states during which the charge carriers are alternatingly stored in the least two charge storages.

In some aspects, performing the plurality of first ToF measurements includes, for at least the one of the plurality of first ToF measurements, controlling the photo-sensitive sensor pixel to continuously and repeatedly operate according to the state pattern over time, wherein each two subsequent sequences of integration states are separated by a drain state.

According to some aspects, the two sequences of integration states include a first sequence of integration states and a second sequence of integration states being different from each other.

In some aspects, the first sequence of integration states and the second sequence of integration states have integration states of different durations.

In some aspects, the first sequence of integration states and the second sequence of integration states have different respective numbers of integration states.

According to some aspects, the integration states within a respective one of the first sequence of integration states and the second sequence of integration states have a same duration.

In some aspects, a duration of the drain state is chosen to reach a predetermined amount of charge carriers being integrated into the at least two charge storages during the subsequent sequence of integration states.

According to some aspects, the ToF sensor further includes an illumination element, and wherein performing the plurality of first ToF measurements includes, for the at least one of the plurality of first ToF measurements, controlling the illumination element to emit light pulses in groups, wherein each group includes at least two light pulses.

In some aspects, a longest duration separating two subsequent light pulses within each of the groups of light pulses is shorter than a duration separating two subsequent ones of the groups of light pulses.

According to some aspects, only the charge carriers selectively stored in the at least two charge storages during the respective first ToF measurement contribute to the respective correlation function of each of the plurality of first ToF measurements.

In some aspects, controlling the photo-sensitive sensor pixel to selectively store the part of charge carriers generated during the at least one of the plurality of first ToF measurements in the at least two charge storages includes controlling the photo-sensitive sensor pixel to increase a ratio of the charge carriers selectively stored in the at least two charge storages with increasing distance of the ToF sensor to an object in the scene causing the incident light.

According to some aspects, different time offsets are used respectively for the plurality of first ToF measurements between a respective sequence of modulated light pulses emitted to the scene during the respective first ToF measurement and one or more respective drive signal used to drive the photo-sensitive sensor pixel during the respective first ToF measurement.

In some aspects, the time offsets used for the first ToF measurements are integer multiples of a fraction of a first period length given by the inverse of the first modulation frequency.

According to some aspects, for one of the plurality of first ToF measurements, the photo-sensitive sensor pixel is controlled to selectively store part of the charge carriers generated during the one of the plurality of first ToF measurements in the at least two charge storages according to a first storage order, wherein, for another one of the plurality of first ToF measurements, the photo-sensitive sensor pixel is controlled to selectively store part of the charge carriers generated during the other one of the plurality of first ToF measurements in the at least two charge storages according to a second storage order, the second storage order being inverted with respect to the first storage order.

In some aspects, the respective correlation function of each of the plurality of first ToF measurements gives the photo-sensitive sensor pixel's distance-dependent correlation of the incident light with one or more respective drive signal and without considering the intensity of the light, the photo-sensitive pixel being driven based on the one or more respective drive signal during the respective first ToF measurement.

In some aspects, controlling the photo-sensitive sensor pixel to selectively prevent the other part of the charge carriers generated during the at least one of the plurality of first ToF measurements from reaching the at least two charge storages includes controlling the photo-sensitive sensor pixel to selectively drain, via a drain terminal of the photo-sensitive sensor pixel, the other part of the charge carriers generated during the at least one of the plurality of first ToF measurements.

According to some aspects, the method further includes performing, by the ToF sensor, a plurality of second ToF measurements using a second modulation frequency in order to obtain second measurement values, wherein a respective correlation function of each of the plurality of second ToF measurements is periodic and exhibits an increasing amplitude over distance within the measurement range of the ToF sensor wherein determining the distance to the object in the scene is further based on the second measurement values, and wherein performing the plurality of second ToF measurements includes for at least one of the plurality of second ToF measurements controlling the photo-sensitive sensor pixel to: selectively store, in the at least two charge storages of the photo-sensitive sensor pixel, part of charge carriers generated in the photo-sensitive sensor pixel during the at least one of the plurality of second ToF measurements by incident light; and selectively prevent another part of the charge carriers generated during the at least one of the plurality of second ToF measurements from reaching the at least two charge storages.

In some aspects, only the charge carriers selectively stored in the at least two charge storages during the respective second ToF measurement contribute to the respective correlation function of each of the plurality of second ToF measurements.

According to some aspects, controlling the photo-sensitive sensor pixel to selectively store the part of charge carriers generated during the at least one of the plurality of second ToF measurements in the at least two charge storages includes controlling the photo-sensitive sensor pixel to increase a ratio of the charge carriers selectively stored in the at least two charge storages with increasing distance of the ToF sensor to an object in the scene causing the incident light.

In some aspects, different time offsets are used respectively for the plurality of second ToF measurements between a respective sequence of modulated light pulses emitted to the scene during the respective second ToF measurement and one or more respective drive signal used to drive the photo-sensitive sensor pixel during the respective second ToF measurement.

According to some aspects, the time offsets used for the second ToF measurements are integer multiples of a fraction of a second period length given by the inverse of the second modulation frequency.

In some aspects, for one of the plurality of second ToF measurements, the photo-sensitive sensor pixel is controlled to selectively store part of the charge carriers generated during the one of the plurality of second ToF measurements in the at least two charge storages according to a third storage order, wherein, for another one of the plurality of second ToF measurements, the photo-sensitive sensor pixel is controlled to selectively store part of the charge carriers generated during the other one of the plurality of second ToF measurements in the at least two charge storages according to a fourth storage order, the fourth storage order being inverted with respect to the third storage order.

According to some aspects, the respective correlation function of each of the plurality of second ToF measurements gives the photo-sensitive sensor pixel's distance-dependent correlation of the incident light with one or more respective drive signal and without considering the intensity of the light, the photo-sensitive pixel being driven based on the one or more respective drive signal during the respective second ToF measurement.

In some aspects, controlling the photo-sensitive sensor pixel to selectively prevent the other part of the charge carriers generated during the at least one of the plurality of second ToF measurements from reaching the at least two charge storages includes controlling the photo-sensitive sensor pixel to selectively drain, via a drain terminal of the photo-sensitive sensor pixel, the other part of the charge carriers generated during the at least one of the plurality of second ToF measurements.

In some aspects, determining the distance to the object in the scene includes: determining a first distance estimate based on the first measurement values; determining a second distance estimate based on the second measurement values; and determining the distance to the object in the scene based on the first distance estimate and the second distance estimate.

According to some aspects, a course of a ratio of the correlation function of any two of the first ToF measurements is strictly monotonic decreasing or strictly monotonic increasing in the measurement range of the ToF sensor.

Other aspects relate to an apparatus for ToF sensing of a scene. The apparatus includes a ToF sensor configured to perform a plurality of first ToF measurements using a first modulation frequency in order to obtain first measurement values. A respective correlation function of each of the plurality of first ToF measurements is periodic and exhibits an increasing amplitude over distance within a measurement range of the ToF sensor. The apparatus additionally includes a processing circuit configured to determine a distance to an object in the scene based on the first measurement values. The ToF sensor includes at least one photo-sensitive sensor pixel. For at least one of the plurality of first ToF measurements, the ToF sensor is configured to control the photo-sensitive sensor pixel to selectively store, in at least two charge storages of the photo-sensitive sensor pixel, part of charge carriers generated in the photo-sensitive sensor pixel during the at least one of the plurality of first ToF measurements by incident light. Further, for the at least one of the plurality of first ToF measurements, the ToF sensor is configured to control the photo-sensitive sensor pixel to selectively prevent another part of the charge carriers generated during the at least one of the plurality of first ToF measurements from reaching the at least two charge storages.

In some aspects, for the at least one of the plurality of first ToF measurements, the ToF sensor is configured to control the photo-sensitive sensor pixel to selectively prevent the other part of the charge carriers from reaching the at least two charge storages by selectively draining the other part of the charge carriers via a drain terminal of the photo-sensitive sensor pixel.

Aspects of the present disclosure may provide a ToF depth sensing method with high dynamic range and without the need of capturing additional images. For example, high dynamic range ToF sensing may be enabled by pixel drainage.

The aspects and features described in relation to a particular one of the previous aspects may also be combined with one or more of the further aspects to replace an identical or similar feature of that further aspect or to additionally introduce the features into the further aspect.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further aspects, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate aspect. It should also be noted that although in the claims a dependent claim refers to a particular combination with one or more other claims, other aspects may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. A method for Time-of-Flight (ToF) sensing of a scene, the method comprising:
performing, by a ToF sensor comprising a photo-sensitive sensor pixel, a plurality of first ToF measurements using a first modulation frequency in order to obtain first measurement values, wherein a respective correlation function of each of the plurality of first ToF measurements is periodic and exhibits an increasing amplitude over distance within a measurement range of the ToF sensor; and
determining a distance to an object located in the scene based on the first measurement values, wherein performing the plurality of first ToF measurements comprises, for at least one of the plurality of first ToF measurements, controlling the photo-sensitive sensor pixel to:
selectively store, in at least two charge storages of the photo-sensitive sensor pixel, a first part of charge carriers generated in the photo-sensitive sensor pixel by incident light during the at least one of the plurality of first ToF measurements; and
selectively prevent a second part of the charge carriers generated during the at least one of the plurality of first ToF measurements from reaching the at least two charge storages.

2. The method of claim 1, wherein the photo-sensitive sensor pixel is configured to provide a respective integration state for each of the least two charge storages during which charge carriers of the first part of the charge carriers are being stored in a corresponding charge storage, wherein the photo-sensitive sensor pixel further provides a drain state during which the second part of the charge carriers are prevented from reaching the at least two charge storages, and
wherein performing the plurality of first ToF measurements comprises, for at least the one of the plurality of first ToF measurements, controlling the photo-sensitive sensor pixel to operate according to a state pattern, the state pattern comprising first the drain state, followed by a sequence of integration states during which the charge carriers of the first part of the charge carriers are alternatingly stored in the least two charge storages.

3. The method of claim 2, wherein performing the plurality of first ToF measurements comprises, for at least the one of the plurality of first ToF measurements, controlling the photo-sensitive sensor pixel to continuously and repeatedly operate according to the state pattern over time, wherein each two subsequent sequences of integration states are separated by the drain state.

4. The method of claim 3, wherein the two subsequent sequences of integration states comprise a first sequence of integration states and a second sequence of integration states being different from each other.

5. The method of claim 4, wherein the first sequence of integration states and the second sequence of integration states have integration states of different durations.

6. The method of claim 4, wherein the first sequence of integration states and the second sequence of integration states have different respective numbers of integration states.

7. The method of claim 6, wherein the integration states within a respective one of the first sequence of integration states and the second sequence of integration states have a same duration.

8. The method of claim 2, wherein a duration of the drain state is selected to reach a predetermined amount of charge carriers being integrated into the at least two charge storages during the sequence of integration states.

9. The method of claim 2, wherein the ToF sensor further comprises an illumination element, and wherein performing the plurality of first ToF measurements comprises, for the at least one of the plurality of first ToF measurements, controlling the illumination element to emit light pulses in groups of light pulses, wherein each group of light pulses comprises at least two light pulses.

10. The method of claim 9, wherein a longest duration separating two subsequent light pulses within each of the groups of light pulses is shorter than a duration separating two subsequent ones of the groups of light pulses.

11. The method of claim 1, wherein only the first part of the charge carriers selectively stored in the at least two charge storages during a respective first ToF measurement contribute to the respective correlation function of each of the plurality of first ToF measurements.

12. The method of claim 1, wherein controlling the photo-sensitive sensor pixel to selectively store the first part of the charge carriers generated during the at least one of the plurality of first ToF measurements in the at least two charge storages comprises:
controlling the photo-sensitive sensor pixel to increase a ratio of the first part of the charge carriers selectively stored in the at least two charge storages with increasing distance of the ToF sensor to the object located in the scene causing the incident light.

13. The method of claim 1, wherein different time offsets are used respectively for the plurality of first ToF measurements between a respective sequence of modulated light pulses emitted to the scene during a respective first ToF measurement and one or more respective drive signals used to drive the photo-sensitive sensor pixel during the respective first ToF measurement.

14. The method of claim 13, wherein the different time offsets used for the plurality of first ToF measurements are integer multiples of a fraction of a period length given by an inverse of the first modulation frequency.

15. The method of claim 1, wherein, for a first one of the plurality of first ToF measurements, the photo-sensitive sensor pixel is controlled to selectively store part of the first part of the charge carriers generated during the first one of the plurality of first ToF measurements in the at least two charge storages according to a first storage order, and
wherein, for a second one of the plurality of first ToF measurements, the photo-sensitive sensor pixel is controlled to selectively store part of the first part of the charge carriers generated during the second one of the plurality of first ToF measurements in the at least two charge storages according to a second storage order, the second storage order being inverted with respect to the first storage order.

16. The method of claim 1, wherein the respective correlation function of each of the plurality of first ToF measurements provides a distance-dependent correlation of the incident light with one or more respective drive signals without considering an intensity of the incident light, the photo-sensitive pixel being driven based on the one or more respective drive signals during a respective first ToF measurement.

17. The method of claim 1, wherein controlling the photo-sensitive sensor pixel to selectively prevent the second part of the charge carriers generated during the at least one of the plurality of first ToF measurements from reaching the at least two charge storages comprises controlling the photo-sensitive sensor pixel to selectively drain, via a drain terminal of the photo-sensitive sensor pixel, the second part of the charge carriers generated during the at least one of the plurality of first ToF measurements.

18. The method of claim 1, further comprising:
performing, by the ToF sensor, a plurality of second ToF measurements using a second modulation frequency in order to obtain second measurement values, wherein a respective correlation function of each of the plurality of second ToF measurements is periodic and exhibits an increasing amplitude over distance within the measurement range of the ToF sensor,
wherein determining the distance to the object located in the scene is further based on the second measurement values, and
wherein performing the plurality of second ToF measurements comprises, for at least one of the plurality of second ToF measurements, controlling the photo-sensitive sensor pixel to:
selectively store, in the at least two charge storages of the photo-sensitive sensor pixel, a third part of charge carriers generated in the photo-sensitive sensor pixel by incident light during the at least one of the plurality of second ToF measurements; and
selectively prevent a fourth part of the charge carriers generated during the at least one of the plurality of second ToF measurements from reaching the at least two charge storages.

19. The method of claim 18, wherein only the charge carriers of the third part of the charge carriers selectively stored in the at least two charge storages during a respective second ToF measurement contribute to the respective correlation function of each of the plurality of second ToF measurements.

20. The method of claim 18, wherein controlling the photo-sensitive sensor pixel to selectively store the third part of the charge carriers generated during the at least one of the plurality of second ToF measurements in the at least two charge storages comprises:
controlling the photo-sensitive sensor pixel to increase a ratio of the charge carriers of the third part of the charge carriers selectively stored in the at least two charge storages with increasing distance of the ToF sensor to the object located in the scene causing the incident light.

21. The method of claim 18, wherein different time offsets are used respectively for the plurality of second ToF measurements between a respective sequence of modulated light pulses emitted to the scene during a respective second ToF measurement and one or more respective drive signals used to drive the photo-sensitive sensor pixel during the respective second ToF measurement.

22. The method of claim 21, wherein the different time offsets used for the plurality of second ToF measurements are integer multiples of a fraction of a period length given by an inverse of the second modulation frequency.

23. The method of claim 18, wherein, for a first one of the plurality of second ToF measurements, the photo-sensitive sensor pixel is controlled to selectively store part of the third part of the charge carriers generated during the one of the plurality of second ToF measurements in the at least two charge storages according to a first storage order, and
wherein, for a second one of the plurality of second ToF measurements, the photo-sensitive sensor pixel is controlled to selectively store part of the third part of the charge carriers generated during the second one of the plurality of second ToF measurements in the at least two charge storages according to a second storage order, the second storage order being inverted with respect to the first storage order.

24. The method of claim 18, wherein the respective correlation function of each of the plurality of second ToF measurements gives a distance-dependent correlation of the incident light with one or more respective drive signals without considering an intensity of the incident light, the photo-sensitive pixel being driven based on the one or more respective drive signals during a respective second ToF measurement.

25. The method of claim 18, wherein controlling the photo-sensitive sensor pixel to selectively prevent the second part of the charge carriers generated during the at least one of the plurality of second ToF measurements from reaching the at least two charge storages comprises controlling the photo-sensitive sensor pixel to selectively drain, via a drain terminal of the photo-sensitive sensor pixel, the second part of the charge carriers generated during the at least one of the plurality of second ToF measurements.

26. The method of claim 18, wherein determining the distance to the object located in the scene comprises:
determining a first distance estimate based on the first measurement values;
determining a second distance estimate based on the second measurement values; and
determining the distance to the object located in the scene based on the first distance estimate and the second distance estimate.

27. The method of claim 1, wherein a trajectory of a ratio of the respective correlation function of any two of the first ToF measurements is strictly monotonic decreasing or strictly monotonic increasing in the measurement range of the ToF sensor.

28. An apparatus for Time-of-Flight (ToF) sensing of a scene, the apparatus comprising:
a ToF sensor configured to perform a plurality of first ToF measurements using a first modulation frequency in order to obtain first measurement values, wherein a respective correlation function of each of the plurality of first ToF measurements is periodic and exhibits an increasing amplitude over distance within a measurement range of the ToF sensor; and
a processing circuit configured to determine a distance to an object located in the scene based on the first measurement values,
wherein the ToF sensor comprises a photo-sensitive sensor pixel, and
wherein, for at least one of the plurality of first ToF measurements, the ToF sensor is configured to control the photo-sensitive sensor pixel to:
selectively store, in at least two charge storages of the photo-sensitive sensor pixel, a first part of charge carriers generated in the photo-sensitive sensor pixel by incident light during the at least one of the plurality of first ToF measurements; and
selectively prevent a second part of the charge carriers generated during the at least one of the plurality of first ToF measurements from reaching the at least two charge storages.

29. The apparatus of claim 28, wherein, for the at least one of the plurality of first ToF measurements, the ToF sensor is configured to control the photo-sensitive sensor pixel to selectively prevent the second part of the charge carriers from reaching the at least two charge storages by selectively draining the second part of the charge carriers via a drain terminal of the photo-sensitive sensor pixel.
